(19) United States
(12) Patent Application Publication
(10) Pub. No.: US 2003/0015122 A1
(43) Pub. Date: Jan. 23, 2003

(54) Fatty acid and polyolefin wax release agent

(76) Inventors: Christopher J. Moriarty, Mullica Hill, NJ (US); James A. Yavorsky, Mickleton, NJ (US)

Correspondence Address: Patent Counsel, Huntsman Polyurethanes, 286 Mantua Grove Road, West Deptford, NJ, 08066-1732, US

(21) Appl. No.: 10/215,427

(22) Filed: Aug. 9, 2002

Related U.S. Application Data
(63) Continuation of application No. PCT/US00/03496, filed on Feb. 11, 2000.

(51) Int. Cl. C08L 91/00; B29C 31/00

(52) U.S. Cl. 106/268; 264/300

(57) ABSTRACT

Fatty acid/polyolefin wax release agent systems useful in the manufacture of lignocellulosic materials is disclosed. The fatty acid/polyolefin wax release agent systems are particularly useful in the manufacture of lignocellulosic materials formed with polyisocyanate binder.

### CROSS-REERNCE TO RELATED APPLICATION

This a continuation of international application number PCT US00/03496, filed Feb. 11, 2000.

### FIELD OF THE INVENTION

This invention relates to release agents comprising a blend of fatty acid and polyolefin wax, which release agents are useful in processes for binding lignocellulosic material, and, in particular, to such processes utilizing polyisocyanate binders.

### BACKGROUND ART

Organic polyisocyanates are known to be superior binders for use with lignocellulosic material, particularly in the manufacture of sheets or molded bodies such as waferboard, chipboard, fiberboard, plywood, etc. In a typical process, the organic polyisocyanate, optionally in the form of a solution, dispersion or aqueous emulsion, is applied to the lignocellulosic material, which is then subjected to heat and pressure. Organic polyisocyanates offer many benefits to conventional binder materials in addition to their superior binding qualities. For example, the use of organic polyisocyanates reduces manufacturing downtime by allowing blenders to be cleaned with greater ease. Also, the organic polyisocyanates improve process efficiency by allowing pressing to take place at higher moisture levels, thereby increasing throughput without increasing emissions.

However, although the organic polyisocyanates provide excellent adhesive properties, they have demonstrated an inherent disadvantage in that they can cause severe sticking of the lignocellulosic material to the metal surfaces of the press plates with which it comes into contact during the pressing operations. Often, the final product is damaged during removal from the press and significant time is required to remove the lignocellulosic material from the surfaces of the press plates.

In order to avoid such adhesion problems, other binding agents, such as phenol formaldehyde, are often used in the faces of the boards to be produced because such binding agents generally cause less sticking of the lignocellulosic material to the surfaces of the press plates. Additionally, barriers such as phenolic impregnated paper, have been used to make products commercially. The phenolic paper is used to cover the strands of lignocellulosic material so that no polyisocyanate coated strands come into contact with the hot press platens. After pressing, the paper is adhered to the panel and becomes part of the final product. However, due to the significant increase in manufacturing costs, such solutions are viable only for very high grade products, such as siding and concrete forms.

The majority of the attempts at solving the adhesion problems that occur with organic polyisocyanate binders focus on the use of release agents such as oils, wax polishes, metallic soaps, silicones and polytetrafluoroethylene. These agents can be used internally (i.e., as an emulsion or mixture with the organic polyisocyanate) or externally (i.e. applied to the metal surfaces of the press plates or to the lignocellulosic material itself).

In general, commonly used internal release agents have not demonstrated significant improvements in release properties or have proven to be too expensive or detrimental to the physical properties of the resulting product. Further, apart from providing satisfactory release, the polyisocyanate compositions containing internal release agents should be stable for a time long enough to allow proper processing of the polyisocyanate/release agent combination on wood binding production lines.

The dominant, commercially used external release agent is based upon fatty acid salts (e.g., potassium oleate, sodium oleate, etc.). However, at typical press temperatures, they cause discoloration of the lignocellulosic materials and cause throat irritation in the press operators. The press temperatures can be lowered in order to significantly eliminate the color problem; however, the resultant decrease in efficiency of the pressing operations is commercially unacceptable.

The use of wax release agents in the binding of lignocellulosic material with polyisocyanates is described in, for example, EP 46014 and EP 57502. The wax is preferably applied in the form of an aqueous dispersion, preferably a dispersion in an aqueous emulsion of the polyisocyanate. Montan wax is preferably used. However, release performance of lignocellulosic bodies bound with polyisocyanate compositions using the above described wax release agents are still not satisfactory insofar that practical usage is limited to 185° C. platen temperature.

The use of a self-release binder system useful for producing lignocellulosic bodies comprising (a) an organic polyisocyanate binder, and (b) a composition comprising a wax and a fatty acid is disclosed in U.S. Pat. No. 5,554,438, issued in the names of Marcinko, et al. Furthermore, U.S. Pat. No. 5,908,496, issued in the names of Singule, et al., discloses a process for the production of sheets or molded bodies from lignocellulosic materials utilizing an organic polyisocyanate binder material and a release agent which is an aqueous emulsion of a polyolefin wax.

### SUMMARY OF THE INVENTION

The present invention is related to a release agent useful for producing lignocellulosic bodies, which release agent comprises a blend of fatty acid and polyolefin wax. The invention is also related to a process for the production of sheets or molded bodies from lignocellulosic materials utilizing an organic polyisocyanate binder material and a release agent that comprises a blend of fatty acid and polyolefin wax. The process includes the steps of treating the lignocellulosic material with the fatty acid and polyolefin wax release agent and the organic polyisocyanate binder material, and pressing the treated lignocellulosic material to form the sheets or molded bodies.

### BRIEF DESCRIPTION OF THE FIGURES

FIG. 1 is a graph which demonstrates the release agent build up of various release agents according to Example 5.

FIG. 2 is a graph demonstrating the effectiveness of the release agents according to Example 6 at various pressing temperatures.

### BEST MODES FOR CARRYING OUT THE INVENTION

The release agent of the invention comprises a blend of fatty acid and polyolefin wax. The blend can be in neat form, emulsifiable form, or in emulsified form.

In an aspect of the invention, the polyolefin wax is used in neat form.

In a further aspect of the invention, the polyolefin wax may be dispersible in an aqueous medium to form an aqueous emulsion. Thus, the polyolefins can be functionalized in order to improve the dispersability in aqueous medium. The polyolefins can be functionalized by means of oxidation, which has the added benefit of improving the release properties of the polyolefin. In one embodiment, the polyolefin wax is selected from oxidized polyethylene waxes and oxidized polypropylene waxes. The oxidized polyethylene waxes can be, for example, oxidized homopolymers of polyethylene or copolymers of polyethylene and α, β-unsaturated carboxylic acids, such as acrylic acid. The oxidized polyethylene wax may have a melting temperature in the range of about 80 to 120° C., a viscosity in the range of about 25 to 200 cPs at 140° C. and a hardness in the range of about 0.5 to 98 dmm. The number average molecular weight of the oxidized polyethylene wax is preferably in the range of about 500 to 5000, most preferably about 500 to 1500. Suitable oxidized polyethylene wax that can be used in the present invention include, for example, AC 629, 655, 656, 680, and 6702, all available from Allied Signal. The oxidized polypropylene waxes useful in the present invention include, for example, oxidized homopolymers of polypropylene which may have a softening point of about 100 to 170° C., a penetration hardness of about 0.1 to 5 dmm and a number average molecular weight of about 3000 to 30,000 and preferably about 4000 to about 12,000. Suitable oxidized polypropylene wax which can be used in the present invention include, for example, EPOLENE 14, 15, 20, and 43 waxes, all available from Eastman Chemicals.

In an aspect of the invention, the oxidized polyolefin wax is an emulsifiable, non-aqueous blend. The emulsifiable, non-aqueous blend of polyolefin wax can be made by any suitable method, including those well known to the skilled artisan, for example, by simply stirring the polyolefin wax in a vessel heated to a temperature above the melting point of the wax.

When utilized, the aqueous emulsion of the polyolefin wax can be made by any suitable method, such as by high shear mixing. However, in an embodiment of the invention, the emulsion will preferably further comprise an emulsifier to improve the capability of the polyolefin with the aqueous medium. Suitable emulsifiers used can either be anionic, non-ionic, or cationic emulsifiers, with anionic emulsifiers being preferred when the wax emulsion is used as an external release agent and non-ionic emulsifiers being preferred when the wax emulsion is used as an internal release agent. The emulsifiers can be used in an amount of about 1 to about 10 and preferably about 4 to about 7% by weight of the total emulsion.

Examples of suitable anionic emulsifiers include the carboxylates, sulphates, sulphonates and phosphates, such as alkylbenzene derivatives; alkyl ether carboxylic acids and salts, e.g., sodium alkyl ether carboxylates; alkyl sulphosuccinates, e.g., di-sodium monoalkylsulphosuccinate, sodium di-alkyl sulphosuccinates and disodium monoalkyl ethoxy sulphosuccinates; alpha olefin sulphonates; aromatic hydrocarbon suphohic acids, e.g., benzene sulphonic acid blends, cumene sulphonic acid, phenol sulphonic acid, toluene sulphonic acid and xylene sulphonic acid; aromatic hydrocarbon sulphonate salts, e.g., ammonium xylene sulphonate, dihydroxyl diphenyl sulphones, naphthalene sulphonates and sodium toluene sulphonates; fatty alcohol ethoxy sulphates, e.g., ammonium lauryl ethoxy sulphates and triethanolamine lauryl ethoxy sulphate; fatty alcohol sulphates, e.g., ammonium lauryl sulphates, monoethanolamine lauryl sulphate and sodium alkyl sulphates; and phosphate esters, e.g., alkyl phenol ethoxy phosphate ester and fatty alcohol phosphate ester. Examples of suitable non-ionic emulsifiers include fatty acid esters of alcohols, ethylene glycol, polyethylene glycol, propylene glycol, glycerine, polyglycerine, sorbitol, pentaerythritol, polyamines, polyglycol ethers of alcohols, thioalcohols, fatty acid esters, fatty acid amines, fatty acid alkanolamides, alkyl phenols, polysiloxanes, polypropylene glycol, ethers of alcohols, fatty acids, fatty amines, and oxo-alcohols such as isooctyl-alcohol. These non-ionic emulsifiers can be made anionic through their combination with suitable base materials, such as potassium hydroxide. Non-ionic emulsifiers are preferably used in case the polyolefin wax emulsion is used as internal release agent; the potlife of the emulsion used in combination with the polyisocyanate is improved, ensuring enough processing window in wood mills. Examples of suitable cationic emulsifiers include alkyl dimethylamines and quaternary ammonium compounds.

Particularly preferred polyethylene wax emulsions that can be used in the present invention are ADD 9887 and ADD 9898, which are 30% non-ionic polyethylene wax emulsions available from Huntsman Polyurethanes, West Deptford, N.J. and BSP-32W (30% solids anionic polyethylene wax emulsion) available from Blackhawk Specialties, Inc. of Rock Island, Ill. One preferred polypropylene wax emulsion which can be used in the present invention is ME 42040 (an 40% anionic emulsion of EPOLENE E 43 wax) available from Michelman, Inc. of Cincinnati, Ohio.

When the polyolefin wax is an aqueous emulsion, the aqueous emulsion preferably has a non-aqueous components content of from about 1 to 40% by weight, more preferably from about 2 to 20%, more preferably from about 5 to 15% and even more preferably from about 5 to 10% by weight non-aqueous components.

Useful fatty acids include, for example, any naturally occurring or synthetically manufactured saturated or unsaturated monobasic, di-basic or polybasic fatty acid. Typically, the fatty acids are composed of a chain of alkyl groups containing from 4 to 22 carbon atoms and having a terminal carboxyl group —COOH. Preferably, the fatty acids utilized in the present invention are those that comprise an acid having an aliphatic chain of about 8 to about 24 carbon atoms. Preferably, the fatty acid is one having an aliphatic chain of about 8 to about 20, and most preferably about 16 to about 18 carbon atoms. Examples of preferred fatty acids useful in the present invention are stearic acid, oleic acid, lauric acid, myristic acid, palmitic acid, linoleic acid, linolenic acid and mixtures thereof. Most preferably, the fatty acid used in the present invention is oleic acid.

Metallic fatty acids may also be useful in the invention. Preferred metallic fatty acids are those that comprise an acid having an aliphatic chain of about 4 to about 24 carbon atoms, and preferably about 12 to about 20, such as oleic acid, stearic acid, lauric acid, myristic acid, plamitic acid, linoleic acid and linolenic acid. Any metallic compound may be used to form the acid salt. Examples of suitable metallic compounds include aluminum, barium, calcium, lithium, magnesium, potassium, sodium and zinc. The most preferred metallic compound is zinc. The fatty acid may be used in any suitable form, including neat, emulsifiable and emulsified.

In an aspect of the invention, the fatty acid is provided as an aqueous emulsion. Any suitable method may be used to form such aqueous emulsions. For example, the fatty acid may be mixed by hand mixing with a surfactant and then high sheer-mixed with de-ionized water to form an emulsion. Methods for forming aqueous emulsions of the fatty acid are well known to an artisan of ordinary skill. When the fatty acid is an aqueous emulsion, the aqueous emulsion preferably has a non-aqueous components content of from about 1 to 40% by weight, more preferably from about 2 to 20%, and even more preferably from about 5 to 10% by weight non-aqueous components content.

As should now be understood, the fatty acid and polyolefin wax release agents of the invention can be used as either a neat blend, a non-aqueous, emulsifiable blend, or an aqueous, emulsified blend. For example, the neat blend or non-aqueous, emulsifiable blend may be preferred when it is desirable to reduce shipping costs of the release agent blend. Because the blend is non-aqueous, a significant portion of shipping weight and space (i.e., water) is eliminated. When received at the point of use, the non-aqueous, emulsifiable blend can be emulsified simply be adding water and mixing, without the requirement of added heat or pressure. In this embodiment, the non-aqueous, emulsifiable polyolefin wax and the non-aqueous, emulsifiable fatty acid can be separately prepared and then mixed together to form the non-aqueous blend at the point of use. Of course, it is also possible to ship the fatty acid and the polyolefin wax as separate products, which can be blended together in suitable ratios at the point of use. In the case where it is desired to first form the emulsified polyolefin wax and the emulsified fatty acid separately, these emulsions can be either mixed together prior to shipping, or shipped in separate containers for blending at the point of use.

The aqueous emulsion of the fatty acid/polyolefin wax blend useful in the present invention should contain a sufficient amount of fatty acid/polyolefin wax to provide a coverage of about 0.1 to about 1.6 and preferably about 0.2 to about 0.9 milligrams of the fatty acid/polyolefin wax per square cm of lignocellulosic material. Generally, the lower levels of fatty acid/polyolefin wax are preferred as they are more cost effective.

When the fatty acid and polyolefin wax blend is used as an emulsion, any ratio of fatty acid to polyolefin wax may be useful; however, the emulsion blend preferably is from about 20 to 90% fatty acid by weight, more preferably from about 40 to 80% fatty acid, and even more preferably from about 60 to 80% fatty acid by weight, based on the total weight of the fatty acid and polyolefin wax only.

In general, it has been found that the present fatty acid/polyolefin wax blend, when used as external release agent, may be applied to the lignocellulosic material in an amount of about 2 to about 35 and preferably about 8 to about 16 and most preferably about 10 milligram/square cm. However, it is understood that the amount of application can be varied as needed for a particular purpose.

The blend of the present invention may also contain other additives, such as flame retardants, lignocellulosic preserving agents, fungicides, waxes, sizing agents, biocides, fillers, other binders (such as formaldehyde condensate adhesives) and catalysts.

Using the fatty acid/polyolefin wax blends of the invention in a process for binding lignocellulosic material with polyisocyanates leads to improved release compared to many conventional processes. Board properties are not detrimentally influenced. Moreover, the fatty acid/polyolefin wax blends of the invention result in good release memory and little or no build-up on the press surfaces. Further, these fatty acid/polyolefin wax blends are effective in a wider temperature range than conventional wax release agents, for example montan wax (max 185° C.), and, thus, higher press temperatures can be used which speeds up the cure process.

Furthermore, it may be desirable to add surfactants to disperse the fatty acid and polyolefin waxes in water. Such surfactants can be ionic, anionic, cationic, non-ionic, or amphoteric in nature. A preferred surfactant for the fatty acid is a non-ionic octophenol ethoxylate. The fatty acid/polyolefin wax blend release systems of the present invention are intended to be used with a wide range of polyisocyanate based binders, which are discussed, generally, below.

The organic polyisocyanates which are useful as a binder according to the present invention include any organic polyisocyanate compound or mixture of organic polyisocyanate compounds provided said compounds have at least two isocyanate groups. Suitable organic polyisocyanates include diisocyanates, particularly aromatic diisocyanates, and isocyanates of higher functionality.

Examples of organic polyisocyanates which may be used in the process of the present invention include aliphatic isocyanates such as hexamethylene diisocyanate; aromatic isocyanates, such as m- and p-phenylene diisocyanate, tolylene-2,4- and -2,6-diisocyanate, diphenylmethane-4,4′-diisocyanate, chlorophenylene-2,4-diisocyanate, naphthylene-1,5-diisocyanate, diphenylene-4,4′diisocyanate, 4,4′-diisocyanate-3,3′-dimethyldiphenyl, 3-methyldiphenylmethane-4,4′-diisocyanate and diphenyl ether diisocyanate; and cycloaliphatic diisocyanates such as cyclohexane-2,4- and -2,3-diisocyanate, 1-methylcyclohexyl-2,4- and -2,6-diisocyanate and mixtures thereof and bis-(isocyanatocyclohexyl)methane and triisocyanates such as 2,4,6-triisocyanatotoluene and 2,4,4-triisocyanatodiphenylether.

Modified polyisocyanates containing isocyanurate, carbodiimide or uretonimine groups may also be used according to the present invention. Furthermore, blocked polyisocyanates, such as the reaction product of a phenol or an oxide and a polyisocyanate, having a deblocking temperature below the temperature applied when using the polyisocyanate composition may be utilized as the organic polyisocyanate binder in the present process. The organic polyisocyanate may also be an isocyanate-ended prepolymer prepared by reacting an excess of a diisocyanate or a higher functionality polyisocyanate with a polyol.

Water-emulsifiable organic polyisocyanates like those described in UK Patent No. 1,444,933, in European Patent Publication No. 516361, and in PCT Patent Publication No. 91/03082 can also be used.

Mixtures of isocyanates may also be used in the present process. For example, a mixture of tolylene diisocyanate isomers, such as the commercially available mixtures of 2,4- and 2,6-isomers and also the mixture of di- and higher polyisocyanates produced by phosgenation of aniline/formaldehyde condensates may be utilized as the organic polyisocyanate binder according to the present invention. Such mixtures are well-known in the art and further include the crude phosgenation products containing methylene bridged polyphenylpolyisocyanates, including diisocyanate, triisocyanate and higher polyisocyanates together with any phosgenation by-products.

Useful isocyanates include those wherein the isocyanate is an aromatic diisocyanate or polyisocyanate of higher functionality, such as pure diphenylmethane diisocyanate or mixture of methylene bridged polyphenyl polyisocyanates containing diisocyanates, triisocyanates and higher functionality polyisocyanates. Such materials are prepared by the phosgenation of corresponding mixtures of polyamines obtained by condensation of aniline and formaldehyde. For convenience, polymeric mixtures of methylene bridged polyphenyl polyisocyanates containing diisocyanate, triisocyanate and higher functionality polyisocyanates are referred to hereinafter as “polymeric MDI”. Both polymeric MDI and emulsifiable MDI or aqueous emulsions thereof can be used. Preferably, the polyisocyanate is liquid at room temperature.

The organic polyisocyanate binder composition may further comprise additives conventionally used in the art such as flame retardants, lignocellulosic preserving agents, fungicides, waxes, sizing agents, fillers, catalysts, surfactants and other binders such as formaldehyde condensate adhesives.

The organic polyisocyanate binder is generally applied to the lignocellulosic material in an amount of about 0.1 to about 25, preferably about 1 to about 10, and most preferably about 2 to about 6% by weight based upon the dry weight of the lignocellulosic material.

According to one aspect of the present invention, the lignocellulosic material is treated with the organic polyisocyanate binder material by means of, for example, mixing, blending, spraying and/or spreading the polyisocyanate composition with or onto the lignocellulosic material. Such application may generally take place in a conventional blender. Thereafter, the treated lignocellulosic material is formed into a mat, preferably upon a screen. Upon forming the lignocellulosic material into a mat, at least a portion of the mat surface can be treated (e.g., by spraying, spreading, etc.) with the fatty acid/polyolefin wax blend release agent. Preferably, all surfaces of the mat which will contact the press platens are treated. The treated lignocellulosic material is then conveyed to a press where pressure is applied thereto at elevated temperatures. The pressing operation generally consists of pressing at 120° C. to 260° C. at pressures of about 2 to 6 MPa. Such binding processes are commonly known in the art. However, it will be recognized by those in the art that the pressing operation may be modified as needed for a particular operation.

According to another aspect of the present invention, the fatty acid/polyolefin wax blend release agent is used as an internal release agent. In such an embodiment, the fatty acid/polyolefin wax release agent blend is either pre-mixed with the polyisocyanate binder and applied to the lignocellulosic material as one stream; this route is advisable when the polyisocyanate is used as an aqueous emulsion or suspension. Otherwise, the fatty acid/polyolefin wax blend release agent and the polyisocyanate binder are applied, preferably simultaneously, to the lignocellulosic material as two separate streams. For both processes, an open time of several minutes on wood substrates may be necessary; hence, the possible need for an extended potlife of the fatty acid/polyolefin wax polyisocyanate combination. Furthermore, the fatty acid/polyolefin wax blend release agent can be applied to the lignocellulosic material with a slack wax or emulsified slack wax.

While the process is particularly suitable for the manufacture of waferboard known extensively as oriented strand board and would largely be used for such manufacture, the process should not be regarded as limited in this regard. The present process can also be used in the manufacture of various types of composite structures, such as, for example, medium density fiberboard, hardboard, particle board (also known as chipboard) and plywood.

The lignocellulosic materials suitable for use in the present process includes all types known in the industry, such as wood strands, wood chips, wood fibers, shavings, veneers, wood wool, cork, bark, sawdust and similar waste products of the woodworking industry as well as other materials having a lignocellulosic basis such as paper, bagasse, straw, flax, sisal, hemp, rushes, reeds, rice hulls, husks, grass, nutshells and the like. Moreover, the lignocellulosic material may be mixed with other particulate or fibrous materials such as mineral fillers, glass fiber, mica, rubber, textile waste such as plastic fibers and fabrics.

The sheets and molded bodies produced according to the present invention have excellent mechanical properties and they may be used in any of the situations where such articles are customarily used.

The following examples are provided to help illustrate certain aspects of the present invention and should be in no way viewed as limiting the scope of the present invention.

### EXAMPLES

### Example 1

An emulsion of a fatty acid was prepared at room temperature using a high sheer-mixing cup attached to a laboratory Waring blender base. Specifically, about 5 grams of Triton-X 100 surfactant (Union Carbide Corporation) was added to about 30 grams of Priolene 6906 oleic acid (Uniqema International Corporation) and hand mixed for about one minute. This mixture was then transferred to a Eberbach high sheer-mixing cup and mixing was started at about 7000 rpm and about 65 grams of de-ionized water was quickly added to the mixture and the mix speed was increased slightly. The emulsion was immediately formed and mixing continued for a total of about 5 minutes. The emulsion had the physical characteristics at 25° C. listed in Table 1:

TABLE 1

| Characteristic | Measured Value |
|---|---|
| % Solids | 35 |
| Viscosity | ˜5 cps |
| pH | 4.8 |
| Appearance | Milky, yellow |

### Example 2

A commercially available emulsified polyethylene wax emulsion (BSP EX 72, oxidized polyethelyne wax emulsion, 35% non-aqueous components, from Blackhawk Specialties, Inc., Rock Island, Ill.) was added to and stirred with the emulsion formed in Example 1 to form a fatty acid/polyolefin emulsified blend release agent. The emulsified release agent blend had the following formulation: 75 grams of the fatty acid emulsion from Example 1 (35% non-aqueous components)+25 grams of BSP EX 72 (oxidized polyethylene wax emulsion, 35% non-aqueous components)=Total emulsion weight of 100 grams. The emulsified release agent blend had the formula and characteristics listed in Table 2:

TABLE 2

| Component | Weight in grams |
|---|---|
| Water | 66.25 |
| Oleic acid | 22.5 |
| Polyethylene wax | 6.25 |
| Morpholene oleate | 1.25 |
| | (present in the polyethylene emulsion) |
| Triton-X 100 surfactant | 3.75 |
| Total | 100 |
| Characteristic | Measured Value |
| % Solids | 33.75 |
| Viscosity | 1 eps |
| PH | 7.3 |
| Appearance | Milky, yellow |

### Example 3

A second fatty acid/polyolefin emulsion release agent blend was prepared by the following method. First, an emulsion of a fatty acid was prepared at room temperature by adding about 4 parts by weight of Triton-X 100 surfactant (Union Carbide Corporation) to about 21 parts by weight Priolene 6906 oleic acid (Uniqema International Corporation) and hand mixed for about 1 minute. To this mixture was added about 75 parts by weight de-ionized water, by stirring in an Eberbach high sheer-mixing cup at about 7000 rpm for about 5 minutes to form the fatty acid emulsion.

Next, a polyethylene wax emulsion was prepared by adding to a Parr pressurized reactor the following: about 40 parts by weight AC 629; about 7 parts by weight of ACINTOL FA2 tall oil fatty acid available from Arizona Chemical; about 7 parts by weight of diethyl amino ethanol; trace amount of KOH; trace amount of Na₂S₂O₅; and about 13.7 parts by weight de-ionized water. The vessel was then heated and pressurized to a temperature of about 125° C. and a pressure of about 2 to 3 bar. The contents of the vessel was stirred for about 30 minutes, while temperature and pressure were maintained. After about 30 minutes, about 124 parts by weight of de-ionized water was added to the reactor and then stirring was continued for about an additional 15 minutes, while maintaining the temperature and pressure at the above levels. After about 15 minutes, the contents of the vessel was cooled to about 25° C., and the thus formed emulsion was recovered from the reactor.

The fatty acid emulsion was then blended with the polyethylene wax emulsion in a fatty acid emulsion to polyethylene wax emulsion weight ratio of about 75:25 by hand mixing. The emulsion had the characteristics at 25° C. listed in Table 3:

TABLE 3

| Characteristic | Measured Value |
|---|---|
| % Solids | 25.4 |
| Viscosity | ˜5 cps |
| PH | 6.7 |
| Appearance | Milky, yellow |

### Example 4

Wood composite panels bonded with polymeric MDI-based binders were pressed to test the release characteristics of the above test release agent. Aspen OSB flakes (having various lengths and widths and about 1 mm thick, with a moisture content ˜6%, Weyerhaeuser Company, Drayton Valley, Canada) were blended with about 4% by weight RUBINATE® M isocyanate (a polymeric MDI available from Huntsman Polyurethanes, West Deptford, N.J.) in a rotary laboratory blender at a rate of about 100 grams of isocyanate per minute. Slack Wax 600 (petroleum slack wax, Exxon Corp., Houston, Tex.) was then spray atomized on the flakes to form a mix. The mix consisted of about 5.5 kg wood flakes, about 209 grams RUBINATE® M isocyanate, and about 55 grams slack wax.

Separate mats of the mix were then hand formed on a screen, and the top surface of each mat was sprayed with about 10 grams of the release agents listed in Table 5. Prior to pressing, the metal surface of the press platens was polished to expose new metal and then solvent cleaned. The mats were then pressed in a programmable logic controller controlled hot press at a temperature of about 205° C. using a pressing cycle of 60 second close, 180 second hold, and 30 second decompression time. The mats were about 30×30 cm and were pressed to a thickness of about 6.4 mm directly to the steel platen surface. Following pressing, the panels were removed from the press and evaluated qualitatively for release performance. Table 4 describes the release rating system:

TABLE 4

| Rating | Description |
|---|---|
| 5 | Perfect release, no sticking to press |
| 4.5 | Slight finger pressure used to obtain release |
| 4 | Slight sticking (in one spot usually) |
| 3 | Light-moderate hand pressure on scraper required for release |
| 2 | Moderate-heavy hand pressure on scraper required for release |
| 1 | Extreme hand pressure on scraper required for release |
| 0 | Completely adhered to metal surface, non-removable |

A series of 10 panels for each release agent were pressed to evaluate release. After the eighth pressing, the release agent spray was discontinued to evaluate the “release memory” of the release agent.

Table 5 demonstrates the release characteristics of 4 tested release agent systems.

TABLE 5

| | | | Emulsified fatty | Emulsified fatty |
|---|---|---|---|---|
| | | | acid/polyolefin wax | acid/polyolefin wax |
| | BSP EX 72 (oxidized | Emulsified oleic acid as | formed in Example | formed in Example |
| | polyethylene wax | prepared in Example 1 | 2 | 3 |
| | emulsion; diluted to | Diluted to 10% non- | Diluted to 10% non- | Diluted to 10% non- |
| | 10% non-aqueous | aqueous components | aqueous | aqueous |
| Board # | components content) | content | components content | components content |
| 1 | 4.5 | 5 | 5 | 5 |
| 2 | 5 | 5 | 5 | 4.5 |
| 3 | 5 | 5 | 5 | 5 |
| 4 | 5 | 4 | 5 | 5 |
| 5 | 5 | 4 | 5 | 4.5 |
| 6 | 5 | 5 | 5 | 5 |
| 7 | 4 | 4.5 | 5 | 5 |
| 8 | 5 | 4 | 5 | 5 |
| 9 (no spray) | 3 | 1 | 3 | 3 |
| 10 (no spray) | 3 | 1 | 3 | 2 |

As can be seen from the data, all four of the systems provide adequate release (i.e., rating greater than 4). However, the oleic acid emulsion, as prepared in Example 1, had essentially no release memory. The addition of a small amount of an oxidized polyethylene wax significantly improved the “release memory” to the level of the polyethylene wax. As will be seen in the examples to follow, the 100% polyethylene wax emulsion suffers from excessive build-up, making it an impractical release system.

### Example 5

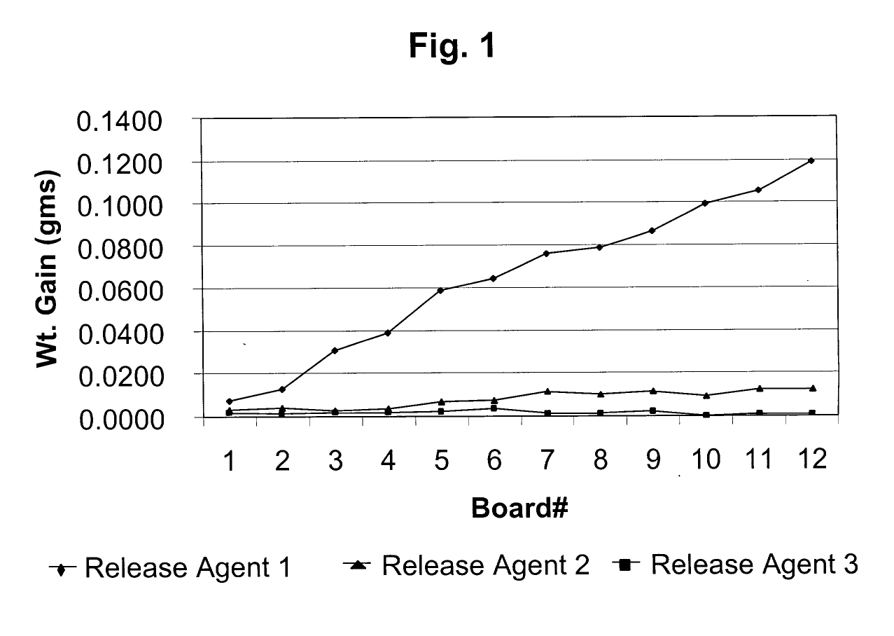

A test method was developed to quantify the release buildup that deposits on the platen of the press over many pressing operations. The method uses a series of panels described in Example 4 with the addition of 4 thin metal shim stock pieces strategically placed over the surface of the panel prior to pressing. After each pressing the shims were weighed with an analytical balance and the weight gain recorded and then placed onto the next panel prior to pressing. Twelve pressings were conducted for each of the following three release agents: AC 6702 polyethylene wax, available from Allied Signal, which had been emulsified and diluted to about 10% non-aqueous components content, “Release Agent 1”; a fatty acid/polyolefin wax release agent blend prepared substantially as set forth in Example 3 and diluted to about 5% by weight non-aqueous components content, “Release Agent 2”; and a fatty acid/polyolefin wax release agent blend prepared substantially as set forth in Example 3 and diluted to about 10% non-aqueous components content, “Release Agent 3”. Each of the three release agents were applied to the top surface of the formed mats at an application rate of about 10 grams of release agent per square foot of mat surface. FIG. 1 displays the average weight gain on the shims vs. board number.

This example reflects the problems that are experienced regarding release buildup on the platen and screen surfaces when only a polyethylene wax emulsion is used as a release agent. As can be seen, the oxidized polyethylene wax based release agent experienced a steady weight buildup over time. The fatty acid/polyethylene wax blends of the present invention by contrast experience much lower buildup.

### Example 6

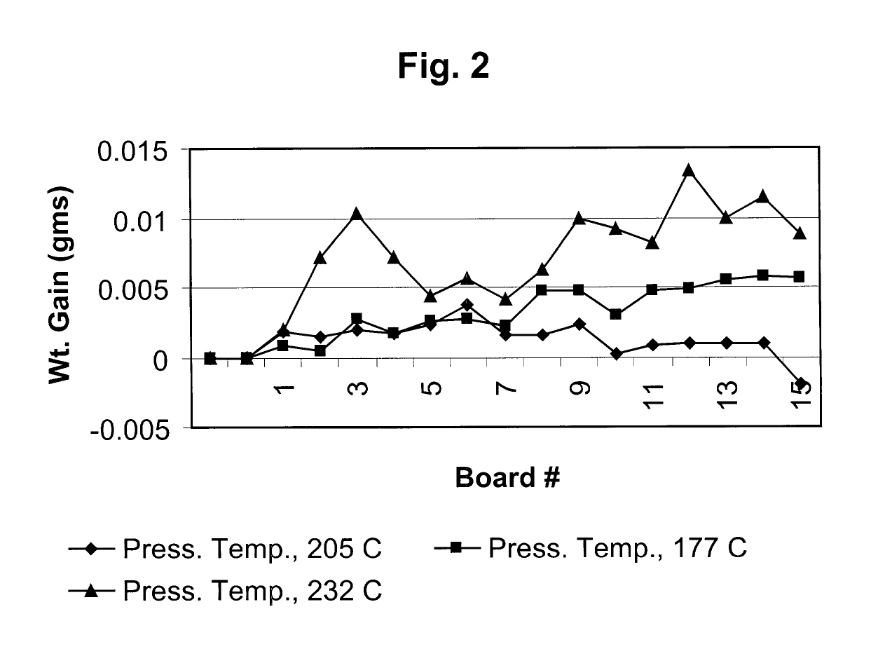

This example demonstrates that the release agents of the present invention can be used at various pressing temperatures and result in little or no build-up. Release testing was conducted using the method explained in Example 5. A release agent was prepared substantially as described in Example 3. Three pressing temperatures were selected and 15 pressing operations were conducted at each temperature, using the release agent described above, which had been diluted to about 10% by weight non-aqueous components content and applied to the top surface of the mats at an application rate of about 10 grams of release agent per square foot of mat surface. The graph depicted in FIG. 2 displays the buildup results at the three pressing temperatures, namely, 177, 205, and 232° C.

### Example 7

This example demonstrates the formation of a non-aqueous, emulsifiable fatty acid/polyolefin wax release agent blend which is subsequently emulsified by mixing with water at room temperature.

About 20 parts by weight AC 6702 polyethylene wax (from Allied Signal) was blended with about 60 parts by weight Priolene oleic acid (from Uniquema, Chicago, Ill.) by stirring the components together at about 90 C. The resultant blend was cooled to about room temperature and was semi-solid at room temperature. The blend was heated to about 30 C and about 40 parts by weight Priolube 1453 methyl oleate (from Uniquema, Chicago, Ill.) was added and stirred together to form a liquid blend.

Three emulsifiable release agent blends were then formed from the liquid blend formed above. Specifically, three samples, weighing about 60 grams each, of the above liquid blend were measured-out. A first release agent blend was formed by adding about 40 grams of Surfonyl L24-9 ethoxylated alcohol, available from Huntsman Surfactants, to the first of the three samples by stirring at room temperature. A second release agent blend was formed by adding about 30 grams of Surfonyl L24-9 ethoxylated alcohol and about 10 grams of Surfonyl L24-5 ethoxylated alcohol, available from Huntsman Surfactants, to the second of the three samples by stirring at room temperature. A third release agent blend was formed by adding about 20 grams of Surfonyl L24-9 ethoxylated alcohol and about 20 grams of Surfonyl L24-5 ethoxylated alcohol to the third of the three samples by stirring at room temperature.

All three release agent blends were then emulsified by stirring together at room temperature about 10 parts by weight release agent and about 90 parts by weight water. It was noted that the third release agent was the most stable of the three release agents.

A test emulsified release agent was then formed substantially the same as the third release agent formed above, except that the emulsion was formed by stirring together at room temperature about 15 parts by weight of the third release agent and about 85 parts by weight water, thus forming an emulsion having about 15% non-aqueous components content.

A series of 9 wood composite panels were then prepared and tested as set forth in Example 4, with the first 8 mats being sprayed with the test emulsified release agent of this example. Following pressing, the panels were removed from the press and evaluated qualitatively for release performance. Table 6 demonstrates the release characteristics of the test release agent.

TABLE 6

| Board # | Release Rating |
|---|---|
| 1 | 4.5 |
| 2 | 4.5 |
| 3 | 4.5 |
| 4 | 4.5 |
| 5 | 4.5 |
| 6 | 4.5 |
| 7 | 4.5 |
| 8 | 4.5 |
| 9 (no spray) | 3 |

The forgoing examples clearly demonstrate the advantages offered by the present invention. Specifically, the fatty acid/polyolefin release agents of the present invention provide for good release rating, good “release memory”, and little or no build-up as measured at various press temperatures.

What is claimed is:

1. A release agent comprising:
a. a fatty acid that includes a chain of alkyl groups containing from 4 to 22 carbon atoms and having a terminal carboxyl group —COOH, and
b. a polyolefin wax.

2. The release agent of claim 1, wherein the polyolefin wax is functionalized.

3. The release agent of claim 2, wherein the polyolefin wax is selected from the group consisting of oxidized polyethylene wax and oxidized polypropylene wax.

4. The release agent of claim 1, wherein the fatty acid is selected from the group consisting of stearic acid, oleic acid, lauric acid, myristic acid, palmitic acid, linoleic acid, linolenic acid, and combinations thereof.

5. The release agent of claim 1, wherein the fatty acid and the polyolefin wax are emulsifiable.

6. The release agent of claim 5, wherein the fatty acid and the polyolefin wax are emulsified and the release agent further comprises a non-ionic surfactant.

7. The release agent of claim 6, wherein the emulsified fatty acid has a non-aqueous components content from about 1 to about 40% by weight.

8. The release agent of claim 7, wherein the emulsified fatty acid has a non-aqueous components content from about 2 to about 20% by weight.

9. The release agent of claim 8, wherein the emulsified fatty acid has a non-aqueous components content from about 5 to about 10% by weight.

10. The release agent of claim 6, wherein the emulsified polyolefin wax has a non-aqueous components content from about 1 to about 40% by weight.

11. The release agent of claim 10, wherein the emulsified polyolefin wax has a non-aqueous components content from about 2 to about 20% by weight.

12. The release agent of claim 11, wherein the emulsified polyolefin wax has a non-aqueous components content from about 5 to about 10% by weight.

13. The release agent of claim 6, wherein the release agent includes about 20% to about 90% by weight fatty acid and about 10% to about 80% by weight polyolefin wax, based on the total weight of the fatty acid and polyolefin wax.

14. The release agent of claim 13, wherein the release agent includes about 40% to about 80% by weight fatty acid and about 20% to about 60% by weight polyolefin wax, based on the total weight of the fatty acid and polyolefin wax.

15. The release agent of claim 14, wherein the release agent includes about 60% to about 80% by weight fatty acid and about 40% to about 20% by weight polyolefin wax, based on the total weight of the fatty acid and polyolefin wax.

16. The release agent of claim 6, further including at lease one additive.

17. The release agent of claim 16, wherein the at least one additive is selected from the group consisting of flame retardants, lignocellulosic preserving agents, fungicides, waxes, sizing agents, biocides, fillers, and catalysts.

18. A method for forming lignocellulosic material bound with organic polyisocyanate binder comprising:
a. providing a release agent comprising (i) a fatty acid that includes a chain of alkyl groups containing from 4 to 22 carbon atoms and having a terminal carboxyl group —COOH, and (ii) a polyolefin wax,
b. providing an organic polyisocyanate,
c. treating the lignocellulosic material with the release agent and the organic polyisocyanate and forming a mat of treated lignocellulosic material, and
d. pressing the treated lignocellulosic material.

19. The method of claim 18, wherein the fatty acid and polyolefin wax are emulsifiable.

20. The method of claim 19, wherein the fatty acid and polyolefin wax are emulsified and the release agent further comprises a non-ionic surfactant.

21. The method of claim 18, wherein the pressing is conducted in a temperature range of from about 120° C. to about 260° C.

22. The method of claim 18, wherein the polyolefin wax is functionalized.

23. The method of claim 22, wherein the polyolefin wax is selected from the group consisting of oxidized polyethylene wax and oxidized polypropylene wax.

24. A method for forming lignocellulosic material bound with organic polyisocyanate binder comprising:
a. providing a release agent comprising (i) a fatty acid that includes a chain of alkyl groups containing from 4 to 22 carbon atoms and having a terminal carboxyl group —COOH, and (ii) a polyolefin wax,
b. providing an organic polyisocyanate,
c. treating the lignocellulosic material with the organic polyisocyanate and forming the treated lignocellulosic material into a mat,
d. applying the release agent to at least one surface of the mat, and
e. pressing the treated lignocellulosic material.

25. The method of claim 24, wherein the fatty acid and polyolefin wax are emulsifiable.

26. The method of claim 25, wherein the fatty acid and polyolefin wax are emulsified and the release agent further comprises a non-ionic surfactant.

27. The method of claim 24, wherein the pressing is conducted in a temperature range of from about 120° C. to about 260° C.

28. The method of claim 24, wherein the polyolefin wax is functionalized.

29. The method of claim 28, wherein the polyolefin wax is selected from the group consisting of oxidized polyethylene wax and oxidized polypropylene wax.
